(19) United States
(12) Patent Application Publication
(10) Pub. No.: US 2025/0203317 A1
(43) Pub. Date: Jun. 19, 2025

(54) SHOPPING SUPPORT SYSTEM AND SHOPPING SUPPORT METHOD

(71) Applicant: TOSHIBA TEC KABUSHIKI KAISHA, Tokyo (JP)

(72) Inventor: Yoshiyuki Matsui, Mishima Shizuoka (JP)

(21) Appl. No.: 18/746,376

(22) Filed: Jun. 18, 2024

(30) Foreign Application Priority Data
Dec. 15, 2023 (JP) 2023-212444

(51) Int. Cl. H04W 4/021; B62B 3/14; G06Q 10/047

(52) U.S. Cl. CPC H04W 4/021; B62B 3/1424; G06Q 10/047

(57) ABSTRACT

The shopping support system includes a cart terminal to be carried by the customer in a store, a store clerk terminal to be carried by the store clerk, and a server device configured to be communicably connected to the cart terminal and the store clerk terminal. The server device calculates a length of a path along a passage in the store between the cart terminal and the store clerk terminal based on a position of the cart terminal that issues the support request, a position of the store clerk terminal, and store map data storing a structure of the passage and information about a length of the passage, and selects a store clerk who can support the customer using the cart terminal that issues the support request. Then, the server device instructs the selected store clerk terminal of the support for the cart terminal.

### CROSS-REFERENCE TO RELATED APPLICATION

This application is based upon and claims the benefit of priority from Japanese Patent Application No. 2023-212444, filed on Dec. 15, 2023, the entire contents of which are incorporated herein by reference.

### FIELD

Embodiments described herein relate to a shopping support system and a shopping support method.

### BACKGROUND

In the related art, a shopping support system has been proposed in which in response to a customer's call while shopping, a store clerk is dispatched to the customer to provide support.

In such a shopping support system, regardless of the current situation of each store clerk, the store clerk dispatched for the support is selected according to the distance from the customer. Therefore, for example, a store clerk taking a break in a back office may have to be dispatched to provide support when the distance from the customer is small.

### DESCRIPTION OF THE DRAWINGS

FIG. 1 is a schematic configuration diagram of a shopping support system according to an embodiment;

FIG. 2 is a diagram illustrating an example of an appearance of a shopping cart;

FIG. 3 is a hardware block diagram illustrating an example of a hardware configuration of a cart terminal;

FIG. 4 is a hardware block diagram illustrating an example of a hardware configuration of a store clerk terminal;

FIG. 5 is a hardware block diagram illustrating an example of a hardware configuration of a server device;

FIG. 6 is a diagram illustrating an example of store map data;

FIG. 7 is a first diagram illustrating a structure of the store map data;

FIG. 8 is a second diagram illustrating the structure;

FIG. 9 is a diagram illustrating processing of applying current positions of a customer and store clerks to nearby nodes;

FIG. 10 is a diagram illustrating an example of a screen transition of screens displayed on a monitor of the cart terminal when calling a store clerk;

FIG. 11 is a diagram illustrating an example of a screen transition of screens displayed on a monitor of the store clerk terminal when a support request is received from the customer;

FIG. 12 is a functional block diagram illustrating an example of a functional configuration of the shopping support system;

FIG. 13 is a flowchart illustrating an example of a flow of processing performed by the cart terminal when the customer issues a support request;

FIG. 14 is a flowchart illustrating an example of a flow of processing performed by the server device when the customer issues the support request; and

FIG. 15 is a flowchart illustrating an example of a flow of processing performed by the store clerk terminal when the customer issues the support request.

### DETAILED DESCRIPTION

In general, according to one embodiment, a shopping support system and a shopping support method capable of causing a store clerk who can respond to a support request from a customer to support the customer can be provided.

The shopping support system includes a first terminal device configured to be carried by a customer in a store during shopping, a second terminal device configured to be carried by a store clerk, and a server device configured to be communicably connected to the first terminal device and the second terminal device. The first terminal device includes a first position specifying unit, a support request unit, and a self-position transmission unit. The first position specifying unit specifies a position of the first terminal device in the store and outputs the specified position to a server device. The support request unit receives an instruction from the customer and requests support from the store clerk. The self-position transmission unit transmits presence of the first terminal device to the surroundings when the support request unit requests support. The server device includes a position information acquisition unit, a support request acquisition unit, a path calculation unit, a selection unit, and a support instruction unit. The position information acquisition unit acquires current positions of the first terminal device and the second terminal device. The support request acquisition unit acquires a support request from the first terminal device. The path calculation unit calculates the length of a path along a passage in the store between the first terminal device and the second terminal device based on the position of the first terminal device, the position of the second terminal device, and map information storing a structure of the passage and information about the length of the passage. The selection unit selects a store clerk who carries the second terminal device and can respond to the support request from the first terminal device based on the length of the path calculated by the path calculation unit. The support instruction unit instructs the second terminal device carried by the store clerk selected by the selection unit of the support for the customer using the first terminal device. The second terminal device includes a second position specifying unit and a support instruction acquisition unit. The second position specifying unit specifies the position of the second terminal device in the store and outputs the specified position to the server device. The support instruction acquisition unit acquires, from the server device, the support instruction for the customer using the first terminal device that requests support.

### Schematic Configuration of Shopping Support System

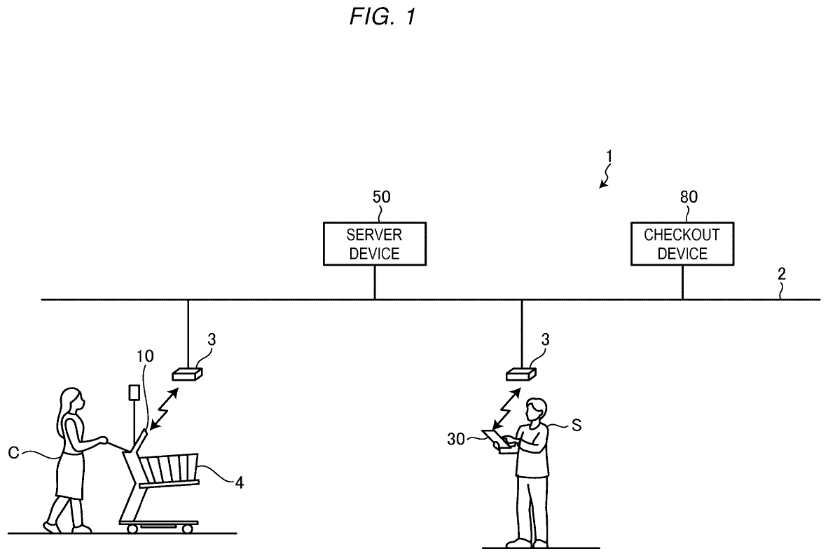

A schematic configuration of a shopping support system 1 will be described with reference to FIG. 1. FIG. 1 is a schematic configuration diagram of the shopping support system according to an embodiment.

The shopping support system 1 includes a cart terminal 10 provided on a shopping cart 4, a store clerk terminal 30, a server device 50, a checkout device 80, and access points 3.

The server device 50 and the checkout device 80 are communicably connected via an in-store network 2. The cart terminal 10, the server device 50, and the checkout device 80 are communicably connected via a plurality of the access points 3 provided in the store. The store clerk terminal 30 and the server device 50 are communicably connected via the access point 3.

The shopping support system 1 guides an available store clerk S to a customer C when the customer C is in trouble and calls a store clerk while shopping. After rushing to the customer C, the store clerk S provides support to solve a problem.

The cart terminal 10 has a commodity registration function of registering a commodity to be purchased by the customer C. The cart terminal 10 has a store clerk call function of calling the store clerk S when the customer C requires support from the store clerk S during shopping. The cart terminal 10 is an example of a first terminal device.

The store clerk terminal 30 is a terminal device such as a tablet terminal or a smartphone carried by the store clerk S. When a call from the customer C to the store clerk S is issued, the store clerk terminal 30 notifies that a support request is issued. The shopping support system 1 does not notify all of the store clerk terminals 30, but notifies only the store clerk terminals 30 carried by the store clerk S near the customer C who requests support. The shopping support system 1 may notify only the store clerk terminals 30 of the store clerks S who can support the customer C among the store clerks S near the customer C who requests support.

The store clerk terminal 30 performs wireless communication with the server device 50 to receive information about business. In addition, the store clerk terminal 30 performs wireless communication with another store clerk terminal 30 to receive the information about business. The store clerk terminal 30 is an example of a second terminal device.

The server device 50 monitors a current position of the cart terminal 10 and a current position of the store clerk terminal 30.

The checkout device 80 performs checkout (may be referred to as accounting or settlement) related to commodity registration information in which a commodity is registered by the customer C using the cart terminal 10. The checkout device 80 performs cash settlement or cashless settlement by a settlement method selected by the customer C. The cash settlement is a settlement method performed using bills and coins. The cashless settlement is to perform payment for a price related to the commodity registration information registered by the cart terminal 10 without using cash. The cashless settlement includes credit settlement, code settlement, electronic money settlement, and the like.

### Configuration of Shopping Cart

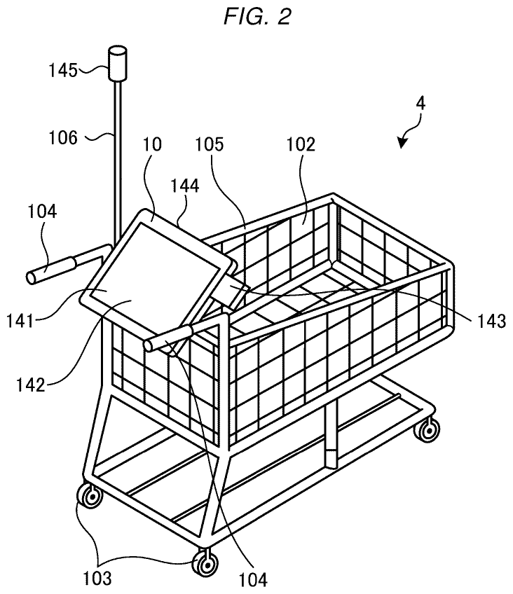

A configuration of the shopping cart 4 will be described with reference to FIG. 2. FIG. 2 is a diagram illustrating an example of an appearance of the shopping cart.

The shopping cart 4 includes a cage-shaped storage portion 102 that is opened upward, caster portions 103 for movement disposed below the storage portion 102, and a handle portion 104 connected to the storage portion 102 and gripped by the customer C when moving the shopping cart 4. An entire skeleton of the shopping cart 4 is implemented by a frame 105. The customer C takes out a commodity to be purchased from a shelf and stores the commodity in the storage portion 102. The shopping cart 4 may not include the storage portion 102. For example, a basket reception portion for placing a shopping basket for storing the commodity may be provided, and the shopping basket placed on the basket reception portion may be used as the storage portion 102.

The cart terminal 10 is attached to a side of the handle portion 104 of the shopping cart 4 via a holding portion (not illustrated). The cart terminal 10 includes a monitor 141, a touch panel 142, a scanner 143, and a positioning sensor 144.

The monitor 141 is implemented by a liquid crystal panel or an organic EL panel and displays an operation method of the cart terminal 10, commodity information about the commodity to be purchased, and the like to the customer C.

The touch panel 142 is provided in a state of being stacked on the monitor 141 and acquires an operation instruction of the customer C to the cart terminal 10.

The scanner 143 is provided near the monitor 141 and reads a commodity code registered in a code symbol such as a bar code attached to the commodity. In addition to the scanner 143, the cart terminal 10 may include a handy scanner (not illustrated) that scans the commodity held by the customer C with a hand. When the commodity is heavy, the customer C uses the handy scanner to read the code symbol of the commodity.

When putting the commodity in the shopping cart 4, the customer C holds the code symbol attached to the commodity over the scanner 143. The scanner 143 reads the code symbol held over the scanner 143. Then, the scanner 143 decodes the read code symbol. The cart terminal 10 analyzes a decoded digital signal to acquire the commodity code for specifying the commodity. The cart terminal 10 registers the commodity to be purchased by the customer by storing the acquired commodity code.

The positioning sensor 144 measures a position of the cart terminal 10 in the store. The positioning sensor 144 is, for example, a known global positioning system (GPS) sensor. The positioning sensor 144 may perform Wi-Fi (registered trademark) positioning for estimating a self-position based on a signal intensity between the positioning sensor 144 and the plurality of access points 3 provided in the store.

The shopping cart 4 further includes a warning lamp 145 at a tip of an upright pole 106. When the customer C performs an operation of calling the store clerk with the cart terminal 10, the warning lamp 115 is lighted up or blinks in a predetermined light emission color and a predetermined light emission pattern, thereby informing the surroundings of a position of the cart terminal 10. Since the warning lamp 145 is provided at the tip of the pole 106, that is, at a high position, the store clerk who responds to the call can easily find the customer C.

### Hardware Configuration of Cart Terminal

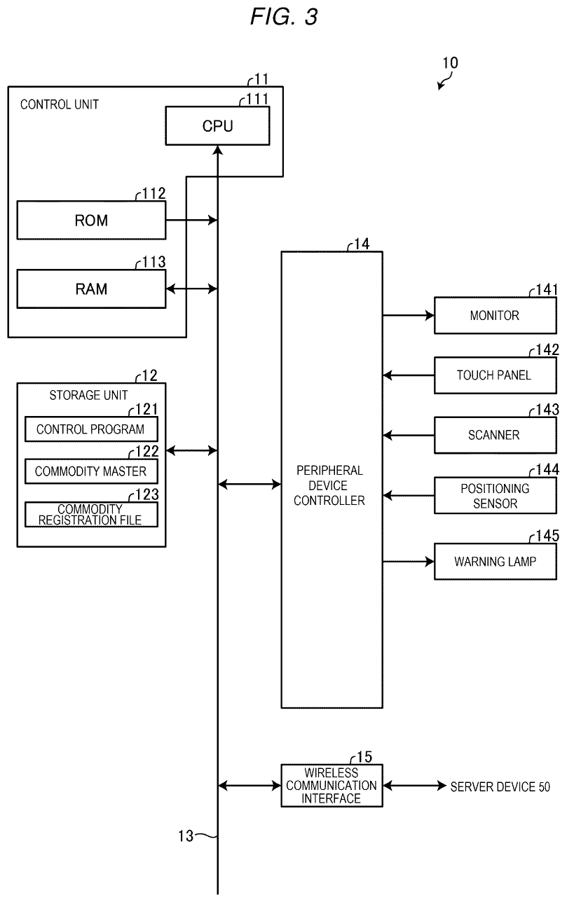

A hardware configuration of the cart terminal 10 will be described with reference to FIG. 3. FIG. 3 is a hardware block diagram illustrating an example of the hardware configuration of the cart terminal included in the shopping cart.

The cart terminal 10 has a configuration in which a control unit 11, a storage unit 12, a peripheral device controller 14, and a wireless communication interface 15 are connected via an internal bus 13.

The control unit 11 controls operations of the entire cart terminal 10. The control unit 11 includes a central processing unit (CPU) 111, a read only memory (ROM) 112, and a random access memory (RAM) 113. The CPU 111 is connected to the ROM 112 and the RAM 113 via an internal bus such as an address bus or a data bus. The CPU 111 loads various programs stored in the ROM 112 or the storage unit 12 into the RAM 113. The CPU 111 controls the operations of the cart terminal 10 by operating according to the various programs loaded in the RAM 113. That is, the control unit 11 has a configuration of a general computer.

The storage unit 12 is a storage device such as an HDD or an SSD. The storage unit 12 may be a nonvolatile memory such as a flash memory in which stored information is maintained even when power is turned off. The storage unit 12 stores a control program 121, a commodity master 122, and a commodity registration file 123.

The control program 121 is a program for controlling the operations of the entire cart terminal 10. The control program 121 may be provided in a state of being stored in the storage unit 12 or may be provided by being recorded in a non-transitory computer-readable recording medium such as a CD-ROM, a flexible disk (FD), a CD-R, or a DVD in an installable or executable file. The control program 121 may be stored in a computer connected to a network and provided by being downloaded via the network. In addition, the control program 121 may be provided or distributed via a network such as the Internet.

The commodity master 122 is a master file in which code information such as a JAN code uniquely allocated to each commodity and the commodity information about the commodity such as a name, a price, and a commodity classification of the commodity are stored in association with each other.

The commodity registration file 123 is a file in which the commodity information (commodity name, unit price, quantity, and the like) corresponding to the commodity code of the commodity registered in the cart terminal 10 is stored.

Through the peripheral device controller 14, the control unit 11 is connected to the monitor 141, the touch panel 142, the scanner 143, the positioning sensor 144, and the warning lamp 145 which perform an input and output of various types of information. An outline of each input and output device is as described above. The peripheral device controller 14 controls operations of these peripheral devices according to an instruction from the control unit 11.

The control unit 11 performs wireless communication with the server device 50 via the wireless communication interface 15.

The cart terminal 10 outputs the self-position corresponding to an output of the positioning sensor 144 to the server device 50 at any time. When the customer C performs the operation of calling the store clerk, the cart terminal 10 requests the server device 50 for support from the store clerk. The cart terminal 10 acquires information indicating that the store clerk S accepts the support request from the server device 50 under a condition that the store clerk S determines to respond to the support request.

When the registration of the commodities is completed, the cart terminal 10 outputs the commodity registration file 123 to the server device 50. After outputting the commodity registration file 123 to the server device 50, the cart terminal 10 acquires a transaction code for uniquely specifying a registration content of the commodity registration file 123 from the server device 50.

### Hardware Configuration of Store Clerk Terminal

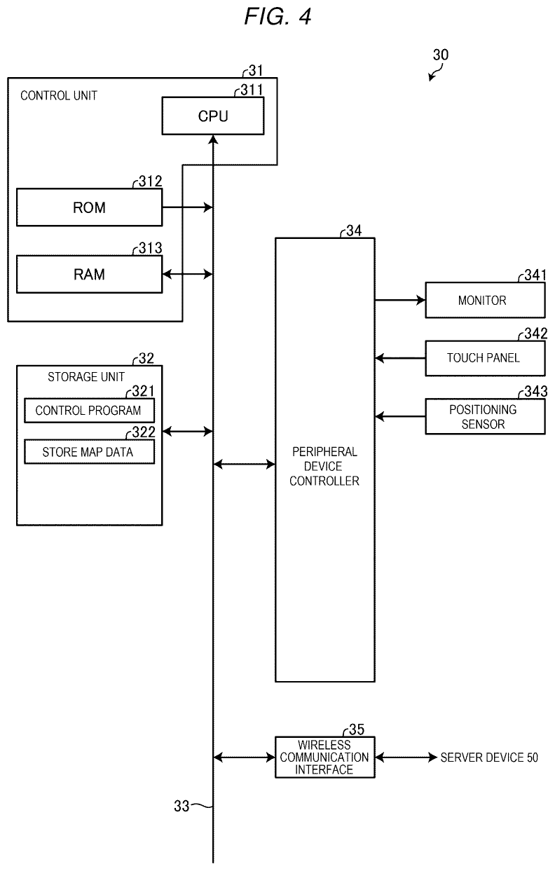

A hardware configuration of the store clerk terminal 30 will be described with reference to FIG. 4. FIG. 4 is a hardware block diagram illustrating an example of the hardware configuration of the store clerk terminal.

The store clerk terminal 30 has a configuration in which a control unit 31, a storage unit 32, a peripheral device controller 34, and a wireless communication interface 35 are connected via an internal bus 33.

The control unit 31 controls operations of the entire store clerk terminal 30. The control unit 31 includes a CPU 311, a ROM 312, and a RAM 313. The CPU 311 is connected to the ROM 312 and the RAM 313 via an internal bus such as an address bus or a data bus. The CPU 311 loads various programs stored in the ROM 312 or the storage unit 32 into the RAM 313. The CPU 311 controls the operations of the store clerk terminal 30 by operating according to the various programs loaded in the RAM 313. That is, the control unit 31 has a configuration of a general computer.

The storage unit 32 is a storage device such as an HDD or an SSD. The storage unit 32 may be a nonvolatile memory such as a flash memory in which stored information is maintained even when power is turned off. The storage unit 32 stores a control program 321 and store map data 322.

The control program 321 is a program for controlling the operations of the entire store clerk terminal 30. The control program 321 may be provided in a state of being stored in the storage unit 32 or may be provided by being recorded in a non-transitory computer-readable recording medium such as a CD-ROM, a flexible disk (FD), a CD-R, or a DVD in an installable or executable file. The control program 321 may be stored in a computer connected to a network and provided by being downloaded via the network. In addition, the control program 321 may be provided or distributed via a network such as the Internet.

The store map data 322 is map data in which a structure of a passage in the store and information about the length of the passage are stored. The store map data 322 further stores the current position of the cart terminal 10 and the current position of the store clerk terminal 30 in association with the store map data 322. The store map data 322 is an example of map information.

Through the peripheral device controller 34, the control unit 31 is connected to a monitor 341, a touch panel 342, and a positioning sensor 343 that perform an input and output of various types of information. The peripheral device controller 34 controls operations of these peripheral devices according to an instruction from the control unit 31.

The monitor 341 is implemented by a liquid crystal panel or an organic EL panel and displays various types of information about in-store management to the store clerk S.

The touch panel 342 is provided in a state of being stacked on the monitor 341 and acquires an operation instruction of the store clerk S to the store clerk terminal 30.

The positioning sensor 343 measures a position of the store clerk terminal 30 in the store. The positioning sensor 343 is the same as the positioning sensor 144 of the cart terminal 10.

The control unit 31 performs wireless communication with the server device 50 via the wireless communication interface 35.

The store clerk terminal 30 outputs a self-position measured by the positioning sensor 343 to the server device 50 at any time. The store clerk terminal 30 outputs, to the server device 50, information indicating whether the support request from the customer C can be responded to. The store clerk terminal 30 further outputs information indicating that the support request from the customer C is accepted to the server device 50.

The store clerk terminal 30 acquires an instruction to respond to the support request from the customer C from the server device 50. The store clerk terminal 30 further acquires information indicating that the support request from the customer C is released from the server device 50.

### Hardware Configuration of Server Device

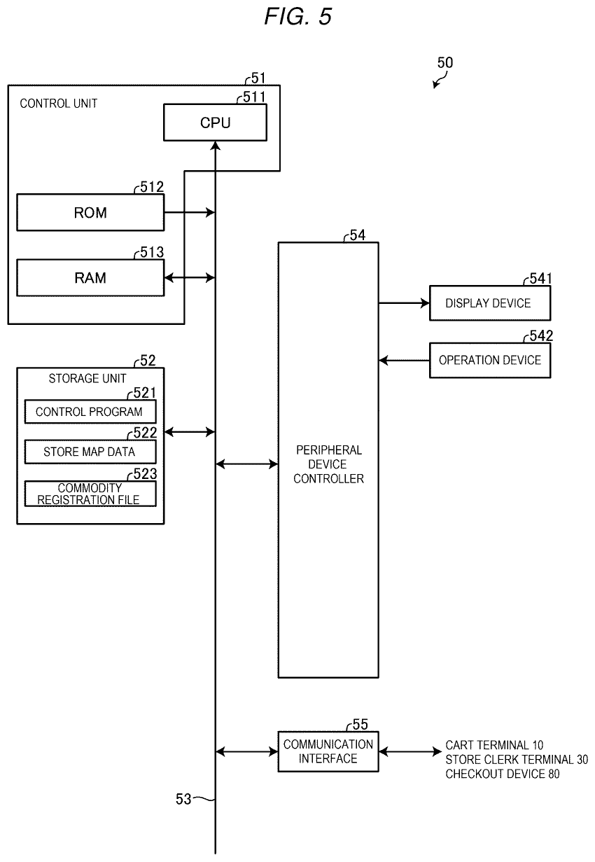

A hardware configuration of the server device 50 will be described with reference to FIG. 5. FIG. 5 is a hardware block diagram illustrating an example of the hardware configuration of the server device.

The server device 50 has a configuration in which a control unit 51, a storage unit 52, a peripheral device controller 54, and a communication interface 55 are connected via an internal bus 53.

The control unit 51 controls operations of the entire server device 50. The control unit 51 includes a CPU 511, a ROM 512, and a RAM 513. The CPU 511 is connected to the ROM 512 and the RAM 513 via an internal bus such as an address bus or a data bus. The CPU 511 loads various programs stored in the ROM 512 or the storage unit 52 into the RAM 513. The CPU 511 controls the operations of the server device 50 by operating according to the various programs loaded in the RAM 513. That is, the control unit 51 has a configuration of a general computer.

The storage unit 52 is a storage device such as an HDD or an SSD. The storage unit 52 may be a nonvolatile memory such as a flash memory in which stored information is maintained even when power is turned off. The storage unit 52 stores a control program 521, store map data 522, and a commodity registration file 523.

The control program 521 is a program for controlling the operations of the entire server device 50. The control program 521 may be provided in a state of being stored in the storage unit 52 or may be provided by being recorded in a non-transitory computer-readable recording medium such as a CD-ROM, a flexible disk (FD), a CD-R, or a DVD in an installable or executable file. The control program 521 may be stored in a computer connected to a network and provided by being downloaded via the network. In addition, the control program 521 may be provided or distributed via a network such as the Internet.

The store map data 522 is map data in which the structure of the passage in the store and the information about the length of the passage are stored. The store map data 522 further stores the current position of the cart terminal 10 and the current position of the store clerk terminal 30 in association with the store map data 522. The store map data 522 is the same as the store map data 322 stored in the store clerk terminal 30. The store map data 522 is an example of the map information.

The commodity registration file 523 is a file in which the transaction code for uniquely specifying a transaction is stored in association with the commodity registration file 123 acquired from the cart terminal 10. The server device 50 stores the commodity registration files 123 acquired from a plurality of the cart terminals 10 in the store.

The control unit 51 is connected, via the peripheral device controller 54, to a display device 541 and an operation device 542 that perform an input and output of various types of information. The display device 541 is implemented by a liquid crystal panel or an organic EL panel and displays various types of screen information and various types of text information to an operator of the server device 50. The operation device 542 is, for example, a touch panel stacked on the display device 541 and acquires an operation instruction of the operator to the server device 50. The peripheral device controller 54 controls operations of these peripheral devices according to an instruction from the control unit 51.

The control unit 51 performs wireless communication with the cart terminal 10 and the store clerk terminal 30 via the communication interface 55. The control unit 51 communicates with the checkout device 80 via the communication interface 55 and the in-store network 2.

The server device 50 acquires the self-position according to the output of the positioning sensor 144 from the cart terminal 10 at any time. The server device 50 acquires the support request from the customer C from the cart terminal 10. The server device 50 acquires the commodity registration file 123 from the cart terminal 10.

The server device 50 outputs the information indicating that the store clerk S accepts the support request to the cart terminal 10. The server device 50 outputs the transaction code for uniquely specifying the registration content of the commodity registration file 123 to the cart terminal 10.

The server device 50 acquires the self-position according to an output of the positioning sensor 343 from the store clerk terminal 30 at any time. The server device 50 acquires the information indicating whether the support request from the customer C can be responded to from the store clerk terminal 30. The server device 50 further acquires the information indicating that the support request from the customer C is accepted from the store clerk terminal 30.

The server device 50 outputs the instruction to respond to the support request from the customer C to the store clerk terminal 30. The server device 50 outputs the information indicating that the support request from the customer C is released to the store clerk terminal 30.

The server device 50 acquires the transaction code read by the customer C by the checkout device 80 from the checkout device 80.

The server device 50 outputs the commodity registration file 523 corresponding to the transaction code to the checkout device 80.

### Structure of Store Map Data

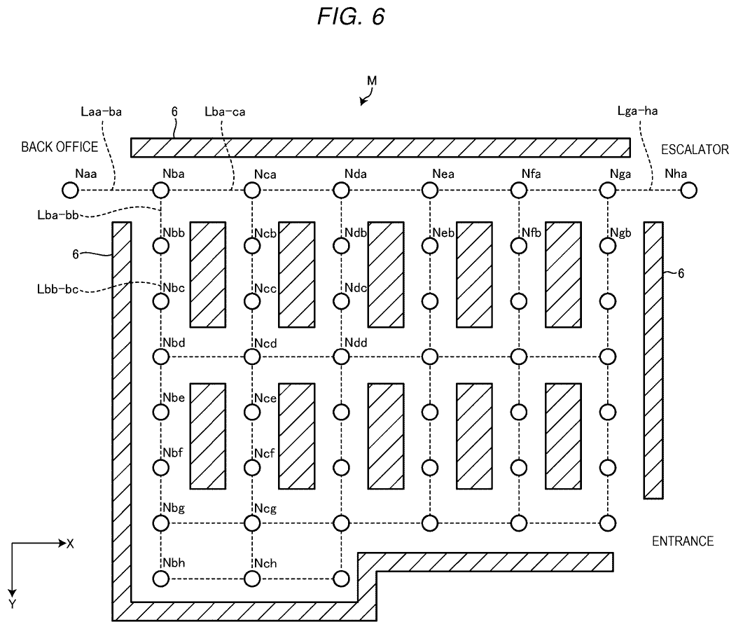

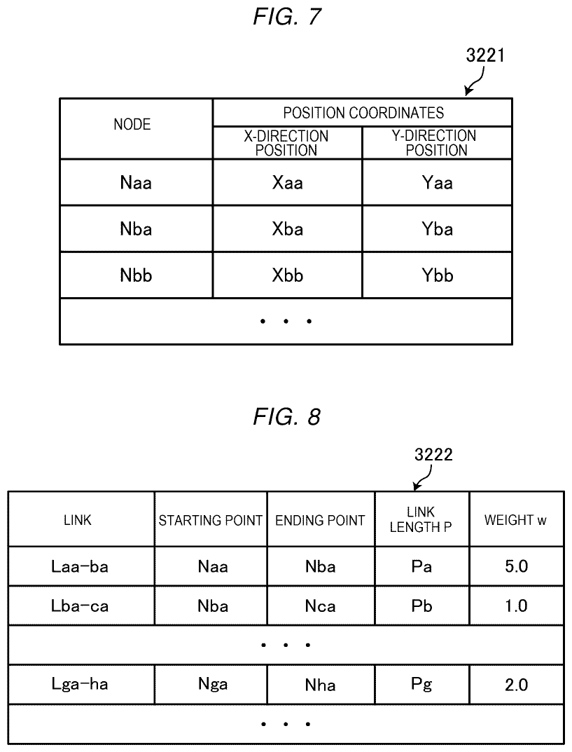

A structure of the store map data 322 or 522 will be described with reference to FIGS. 6 to 8. FIG. 6 is a diagram illustrating an example of the store map data included in the shopping support system. FIG. 7 is a first diagram illustrating the structure of the store map data. FIG. 8 is a second diagram illustrating the structure of the store map data.

As illustrated in FIG. 6, a store map M includes links that form the passages through which the customer C and the store clerk S can move, which are formed between display shelves 6, and nodes that are connection points between the connected links. The map data in this form has the same structure as that of, for example, road map data included in a car navigation system.

If the store has a plurality of floors, the store map M is prepared for each floor.

A Node Nᵢⱼ (i=a, b, c, . . . , j=a, b, c, . . . ) is formed at an inter-unit of the passages in the store and at a predetermined distance along the passage. A subscript i indicates an X-direction position of the node, and a subscript j indicates a Y-direction position of the node. The node Nᵢⱼ is stored in association with the X-direction position and the Y-direction position in the store. Details will be described later (see FIG. 7). In the following description, the nodes are collectively referred to as nodes N.

A Link L_{ij-pq} (i=a, b, c, . . . , j=a, b, c, . . . , p=a, b, c, . . . , q=a, b, c, . . . ) represents a link connecting the node Nᵢⱼ and a node N_{pq}. The link L_{ij-pq} is a link having the node Nᵢⱼ as a starting point and the node N_{pq} as an ending point. The link L_{ij-pq} is stored in association with information for uniquely specifying the node N indicating the starting point, information for uniquely specifying the node N indicating the ending point, a link length P, and a link weight w. Details will be described later (see FIG. 8). In the following description, the link is collectively referred to as a link L.

The link length P represents an actual length of the link L.

The link weight w is a weight coefficient to be given to the link length P of the corresponding link L when calculating the length of a path between two of the nodes N in the store. For example, since the store clerk S who is taking a break in the back office may not want to respond to a call request from the customer C, the weight w exceeding 1.0 is given to the link L_{aa-ba} connecting a sales floor and the back office. Then, the server device 50 regards a multiplied value of the link length P and the weight w as an apparent link length of the link L_{aa-ba}. The apparent link length P is an example of information about the length of the passage. Accordingly, since the link L from the sales floor to the back office is considered to be longer than an actual distance, a distance between the store clerk S in the back office and the customer C is estimated to be longer than the actual distance. Accordingly, the store clerk S in the back office hardly responds to the support request from the customer C.

Similarly, it is desirable that the store clerk S who is on a different floor hardly responds to the call request from the customer C because the store clerk S who is on a different floor hardly responds to the call request from the customer C across the floor via an escalator, an elevator, or stairs. Therefore, the weight w exceeding 1.0 is given to the link L_{ga-ha} leading to a different floor.

In contrast, for example, for the store clerk S who has a main business to respond to the customer C, the main business may be registered in the server device 50, and the server device 50 may give the weight w of less than 1.0 to the link L connected to the node N closest to the current position of the store clerk S. Accordingly, the store clerk S who has the main business to respond to the customer C can easily respond to the support request from the customer C. In this way, the server device 50 may variably set the weight w of the link L depending on the store clerk S.

When acquiring the call request from the customer C, the server device 50 specifies the node N closest to the customer C by comparing the position information about the customer C obtained from the cart terminal 10 with the store map M. When acquiring the call request from the customer C, the server device 50 specifies the node N closest to the store clerk S by comparing position information about the store clerk S obtained from the store clerk terminal 30 with the store map M. Then, the server device 50 calculates a shortest route from the store clerk S to the customer C and the length of a path of the shortest route by referring to the store map M. The shortest route calculated in this way is output to the store clerk terminal 30, and the store clerk S goes to support the customer C along the presented route.

FIG. 7 illustrates an example of node data 3221 included in the store map data 322. The node data 3221 stores information for uniquely specifying the node Nᵢⱼ, for example, a node number and position coordinates of the node Nᵢⱼ in association with the node Nᵢⱼ. The position coordinates of the node Nᵢⱼ are represented by, for example, a left-right direction position X and an up-down direction position Y orthogonal to the left-right direction position X in FIG. 6. The store map data 522 also has the same node data.

FIG. 8 illustrates an example of link data 3222 included in the store map data 322. The link data 3222 stores a starting point, an ending point, the link length P, and the weight w of the link L in association with the link L. The starting point of the link L stores information for uniquely specifying a node corresponding to the starting point, for example, the node number. The ending point of the link L stores information for uniquely specifying a node corresponding to the ending point, for example, the node number. There is no clear definition of the starting point and the ending point, and one of the nodes N serving as end points constituting the link may be the starting point, and the node N serving as the other end point may be the ending point. The link length P stores the actual length of the link L. The weight w stores the weight given to the link L. The weight w may be a fixed value or may be variable depending on the store clerk S as described above. The store map data 522 also has the same node data and link data.

### Application of Current Positions of Customer and Store Clerk to Store Map Data

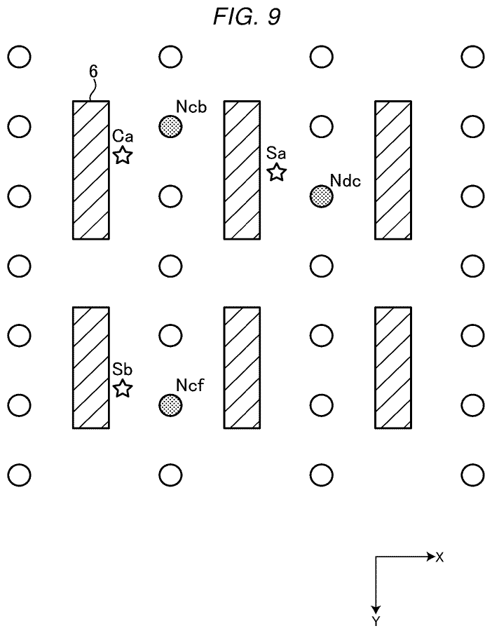

A content of processing in which the server device 50 applies the current positions of the customer C and the store clerk S to the store map data 322 will be described with reference to FIG. 9. FIG. 9 is a diagram illustrating processing of applying the current positions of the customer and the store clerk to nearby nodes in the store map data.

The server device 50 applies the current position of the customer C who requests support, which is acquired from the cart terminal 10, to the store map data 322, and regards the node N closest to the customer C as the current position of the customer C.

Specifically, as illustrated in FIG. 9, the server device 50 determines the node N_{cb} closest to a position of a customer Ca in the store map data 322. Then, the node N_{cb} is regarded as a current position of the customer Ca.

Then, the server device 50 applies the current position of the store clerk S acquired from the store clerk terminal 30 to store map data 322, and regards the node N closest to the store clerk S as the current position of the store clerk S.

Specifically, as illustrated in FIG. 9, the server device 50 determines the node N_{dc} closest to a position of a store clerk Sa in the store map data 322. Then, the node N_{dc} is regarded as a current position of the store clerk Sa. The server device 50 determines the node N_{cf} closest to a position of a store clerk Sb in the store map data 322. Then, the node N_{cf} is regarded as a current position of the store clerk Sb.

### Method of Selecting Store Clerk to Perform Support

The server device 50 calculates a shortest route from the node N_{dc}, that is, the current position of the store clerk Sa to the node N_{cb}, that is, the position of the customer Ca. A shortest route search in the map data implemented by the nodes and the links can be performed by a known route search algorithm. When the shortest route search is performed, the server device 50 uses the multiplied value of the link length P and the weight w instead of the actual link length P. The server device 50 calculates a shortest route from the node N_{cf}, that is, the current position of the store clerk Sb to the node N_{cb}, that is, the position of the customer Ca. Then, the server device 50 selects a shorter one from the calculated shortest route from the store clerk Sa to the customer Ca and the calculated shortest route from the store clerk Sb to the customer Ca. Then, among the store clerks S who declare the support for the customer C can be made, the server device 50 instructs a store clerk close to the customer Ca to support the customer Ca.

There are various variations in a method of selecting a store clerk who is requested to provide support. For example, the server device 50 may instruct only a store clerk whose length of a path to the customer Ca is smallest to support the customer Ca. In addition, the server device 50 may instruct all store clerks whose length of the path to the customer Ca is less than a predetermined value to support the customer Ca. In the latter case, in response to a support instruction, the server device 50 may cause a store clerk who responds first to accept the instruction to support the customer Ca.

Screen Transitions of Screens Displayed on Monitor of Cart Terminal when Store Clerk is Called

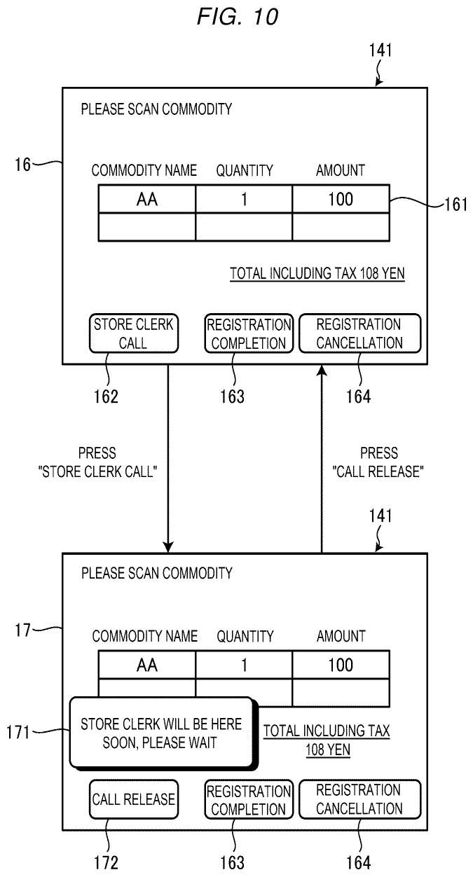

Screen transitions of screens displayed on the monitor 141 of the cart terminal 10 will be described with reference to FIG. 10. FIG. 10 is a diagram illustrating an example of the screen transitions of the screens displayed on the monitor of the cart terminal when calling the store clerk.

While the customer C is shopping, the cart terminal 10 displays a commodity registration screen 16 on the monitor 141. The commodity registration screen 16 includes a commodity store clerk call button 162, a registration completion button 163, and a registration cancellation button 164.

The commodity list displays the commodity 161 information (commodity name, quantity, amount, and the like) about the commodity corresponding to the commodity code read by the cart terminal 10. The customer looks at the commodity list 161 and confirms whether a content of the commodity to be purchased by himself is wrong.

The store clerk call button 162 is a button to be pressed when the support from the store clerk S is required. When the customer C presses the store clerk call button 162, the cart terminal 10 requests the server device 50 for support from the store clerk S.

The registration completion button 163 is a button to be pressed when all the commodities to be purchased are registered. When the customer C presses the registration completion button 163, the cart terminal 10 outputs the commodity registration file 123 (see FIG. 3) to the server device 50.

The registration cancellation button 164 is a button to be pressed when the registration of the commodity is canceled. When the customer C presses the registration cancellation button 164, the cart terminal 10 deletes information about a commodity designated by the customer C after pressing the registration cancellation button 164 from the commodity registration file 123.

When the store clerk call button 162 is pressed, the cart terminal 10 displays a store clerk call screen 17 on the monitor 141.

Support acceptance information 171 indicating that the store clerk S is going to provide support is displayed on the store clerk call screen 17 in a way of being superimposed on the commodity registration screen 16. The support acceptance information 171 is displayed when the cart terminal 10 acquires, from the server device 50, information indicating that the store clerk S accepts the support request.

On the store clerk call screen 17, a call release button 172 is displayed instead of the store clerk call button 162. The customer C presses the call release button 172 when support from the store clerk S is no longer needed. When the call release button 172 is pressed, the cart terminal 10 displays the commodity registration screen 16 described above on the monitor 141.

Screen Transitions of Screens Displayed on Monitor of Store Clerk Terminal when Support Request is Received from Customer

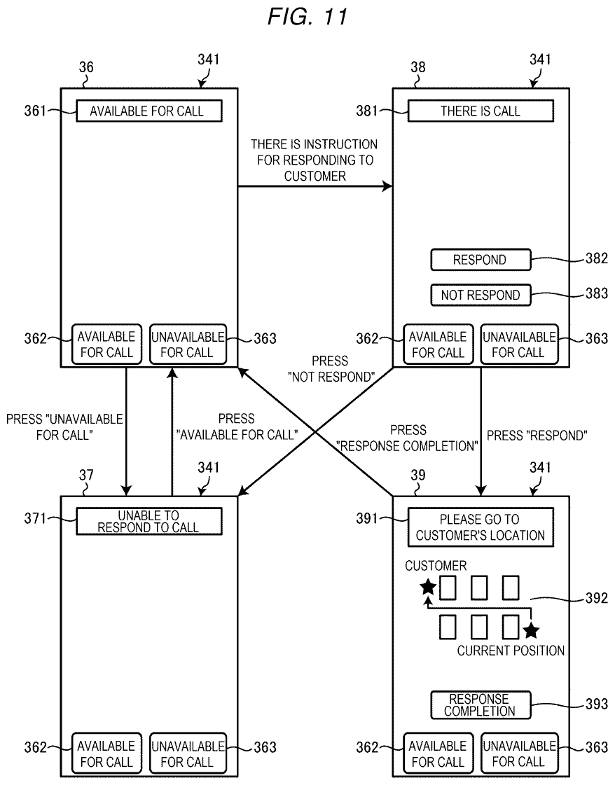

Screen transitions of screens displayed on the monitor 341 of the store clerk terminal 30 when the support request from the customer C is received will be described with reference to FIG. 11. FIG. 11 is a diagram illustrating an example of the screen transitions of the screens displayed on the monitor of the store clerk terminal when the support request from the customer is received.

When receiving a call from the customer C, the store clerk S sets in advance whether the call can or cannot be responded by operating the store clerk terminal 30.

Specifically, the store clerk S declares whether the support for the customer C can be performed by pressing one of a call response available button 362 and a call response unavailable button 363 displayed on the monitor 341 of the store clerk terminal 30. When the call response available button 362 is pressed, it can be declared that the call of the customer can be responded to. At this time, as illustrated in a screen 36 illustrated in FIG. 11, the monitor 341 displays a support available label 361 indicating that it is declared that the call of the customer can be responded to.

In contrast, when the call response unavailable button 363 is pressed, it can be declared that the call of the customer cannot be responded to. At this time, as illustrated in a screen 37 illustrated in FIG. 11, a support unavailable label 371 indicating that it is declared that the call of the customer cannot be responded to is displayed on the monitor 341.

The store clerk S declares whether the call of the customer C can be responded to by pressing one of the call response available button 362 and the call response unavailable button 363 at any time. Whether the store clerk S can respond to the call of the customer C is output to the server device 50.

In a state in which it is declared that the call of the customer C can be responded to, when instructed by the server device 50 to respond to the customer C, a support request label 381 indicating that there is a call from the customer C is displayed on the monitor 341 of the store clerk terminal 30 as in a screen 38 illustrated in FIG. 11. At this time, the store clerk terminal 30 may notify that there is a support request from the customer C by making a sound from a buzzer or a speaker (not illustrated) or by vibrating a vibrator (not illustrated).

At this time, on the screen 38, a support response acceptance button 382 for instructing to respond to the support request from the customer C and a support response unavailable button 383 for instructing not to respond to the support request from the customer C are displayed. In this way, a reason why the support response acceptance button 382 and the support response unavailable button 383 are displayed is that it is uncertain whether the call can be responded to when the support is actually requested even when it is declared that the call of the customer can be responded.

When the store clerk S presses the support response acceptance button 382, a notification is output to the server device 50. The server device 50 determines that the store clerk S agrees to support the customer C, and outputs, to the cart terminal 10 of the customer C, information indicating that the store clerk S is going to provide support. In contrast, when the store clerk S presses the support response unavailable button 383, the server device 50 instructs the store clerk S who is the next candidate to respond to the support request.

When the support response acceptance button 382 on the screen 38 is pressed, a customer support instruction label 391, a movement route 392, and a response completion button 393 are displayed on the monitor 341 as in a screen 39 illustrated in FIG. 11. The customer support instruction label 391 is a label indicating that the support of the customer C is instructed. The movement route 392 represents a movement route from the current position of the store clerk S to the customer C. The store clerk S heads toward the customer C while confirming the movement route 392.

The cart terminal 10 being used by the customer C who requests support lights up the warning lamp 145 (see FIG. 2). Therefore, the store clerk S approaching the customer C can immediately recognize the position of the customer C.

The response completion button 393 is a button that is pressed by the store clerk S when completing support for the customer C. When the response completion button 393 is pressed, the store clerk terminal 30 outputs to the server device 50 that the support for the customer C is completed. At this time, the display on the monitor 341 is switched to the screen 36.

### Functional Configuration of Shopping Support System

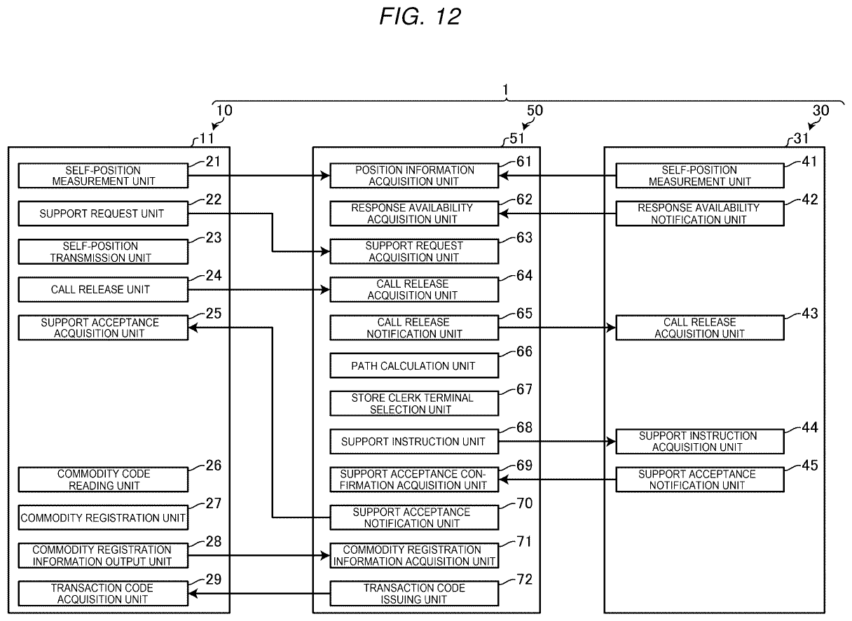

A functional configuration of the shopping support system 1 will be described with reference to FIG. 12. FIG. 12 is a functional block diagram illustrating an example of the functional configuration of the shopping support system.

First, a functional configuration of the cart terminal 10 will be described. The control unit 11 of the cart terminal 10 is implemented as functional units including a self-position measurement unit 21, a support request unit 22, a self-position transmission unit 23, a call release unit 24, a support acceptance acquisition unit 25, a commodity code reading unit 26, a commodity registration unit 27, a commodity registration information output unit 28, and a transaction code acquisition unit 29 illustrated in FIG. 12 by loading the control program 121 in the RAM 113 and operating the loaded control program 121. All or a part of these functional units may be implemented by dedicated hardware.

The self-position measurement unit 21 measures the position of the cart terminal 10 in the store by the positioning sensor 144 (see FIG. 3). Then, the self-position measurement unit 21 outputs the measured position of the cart terminal 10 to the server device 50. The self-position measurement unit 21 is an example of a: first position specifying unit.

The support request unit 22 receives the instruction from the customer and requests support from the store clerk. Specifically, when detecting that the store clerk call button 162 (see FIG. 10) is pressed, the support request unit 22 requests support from the store clerk S to the server device 50.

The self-position transmission unit 23 transmits the presence of the cart terminal 10 to the surroundings when the support request unit 22 requests the store clerk to support. Specifically, the self-position transmission unit 23 lights up or blinks the warning lamp 145 in the predetermined light emission color and a predetermined light emission pattern, thereby informing the surroundings of a position of the cart terminal 10.

In response to an instruction from the customer, the call release unit 24 outputs the information indicating that the support request to the store clerk S is released to the server device 50. Specifically, when detecting that the call release button 172 (see FIG. 10) is pressed, the call release unit 24 cancels the support request to the store clerk S.

The support acceptance acquisition unit 25 acquires, from the server device 50, information indicating that the store clerk S accepts the support request. The support acceptance acquisition unit 25 displays, on the monitor 141, the information indicating that the store clerk S accepts the support request. Specifically, the support acceptance acquisition unit 25 displays, on the monitor 141, the support acceptance information 171 (see FIG. 10) indicating that the store clerk S is going to provide support.

The commodity code reading unit 26 reads the commodity code of the commodity registered in the code symbol held over the scanner 143.

The commodity registration unit 27 registers the commodity code read by the commodity code reading unit 26 in the commodity registration file 123. When the registration completion button 163 (see FIG. 10) is pressed, the commodity registration unit 27 determines that the commodity registration is completed.

When the registration of the commodity is completed, the commodity registration information output unit 28 outputs the commodity registration file 123 to the server device 50 in association with identification information for uniquely specifying the cart terminal 10.

The transaction code acquisition unit 29 acquires a transaction code for uniquely specifying the commodity registration file 123 from the server device 50.

Next, a functional configuration of the store clerk terminal 30 will be described. The control unit 31 of the store clerk terminal 30 is implemented as functional units including a self-position measurement unit 41, a response availability notification unit 42, a call release acquisition unit 43, a support instruction acquisition unit 44, and a support acceptance notification unit 45 illustrated in FIG. 12 by loading the control program 321 in the RAM 313 and operating the loaded control program 321. All or a part of these functional units may be implemented by dedicated hardware.

The self-position measurement unit 41 measures the position of the store clerk terminal 30 in the store by the positioning sensor 343 (see FIG. 4). Then, the self-position measurement unit 41 outputs the measured position of the store clerk terminal 30 to the server device 50. The self-position measurement unit 41 is an example of a second position specifying unit.

The response availability notification unit 42 determines whether the store clerk is in a state of being capable of responding to the support request from the customer C or in a state of being unable to respond to the support request. Specifically, when the support available label 361 (see FIG. 11) is displayed on the monitor 341, the response availability notification unit 42 determines that the store clerk is in the state of being capable of responding to the support request from the customer C. In contrast, when the support unavailable label 371 (see FIG. 11) is displayed on the monitor 341, the response availability notification unit 42 determines that the store clerk is in the state of being unable to respond to the support request from the customer C. The response availability notification unit 42 outputs, to the server device 50, information indicating that the support request from the customer C can be responded to or r that the support request cannot be responded to. Specifically, the response availability notification unit 42 outputs, to the server device 50, a content of the support available label 361 (refer to FIG. 11) or the support unavailable label 371 (refer to FIG. 11) at that time.

The call release acquisition unit 43 acquires the information indicating that the support request from the customer C is released from the server device 50.

The support instruction acquisition unit 44 acquires, from the server device 50, the support instruction for the customer C using the cart terminal 10 requesting support.

The support acceptance notification unit 45 outputs information indicating that the instruction acquired by the support instruction acquisition unit 44 is accepted to the server device 50. Specifically, when the support response acceptance button 382 (see FIG. 11) displayed on the monitor 341 is pressed, the support acceptance notification unit 45 outputs the information indicating that the instruction acquired by the support instruction acquisition unit 44 is accepted to the server device 50. In contrast, when the support response unavailable button 383 (see FIG. 11) displayed on the monitor 341 is pressed, the support acceptance notification unit 45 does not output the information indicating that the instruction acquired by the support instruction acquisition unit 44 is accepted to the server device 50.

Next, a functional configuration of the server device 50 will be described. The control unit 51 of the server device 50 is implemented as functional units including a position information acquisition unit 61, a response availability acquisition unit 62, a support request acquisition unit 63, a call release acquisition unit 64, a call release notification unit 65, a path calculation unit 66, a store clerk terminal selection unit 67, a support instruction unit 68, a support acceptance confirmation acquisition unit 69, a support acceptance notification unit 70, a commodity registration information acquisition unit 71, and a transaction code issuing unit 72 illustrated in FIG. 12 by loading the control program 521 in the RAM 513 and operating the loaded control program 521. All or a part of these functional units may be implemented by dedicated hardware.

The position information acquisition unit 61 acquires the current positions of the cart terminal 10 and the store clerk terminal 30.

The response availability acquisition unit 62 acquires, from the store clerk terminal 30, the information indicating that the store clerk S can or cannot respond to the support request from the customer C.

The support request acquisition unit 63 acquires the support request from the cart terminal 10.

The call release acquisition unit 64 acquires, from the cart terminal 10, the information indicating that the support request to the store clerk S is released.

The call release notification unit 65 notifies the store clerk terminal 30 that the support request for the store clerk S is released.

The path calculation unit 66 calculates the length of a path along a passage between the cart terminal 10 and the store clerk terminal 30 based on the position of the cart terminal 10, the position of the store clerk terminal 30, and the store map data 522 in which the structure of the passage in the store and the information about the length of the passage are stored. The path calculation unit 66 calculates the length of a path of the shortest route from the store clerk S to the customer C based on a sum of the multiplied values of the link lengths P of all the links L constituting the route from the store clerk terminal 30 to the cart terminal 10 and the weight w attached to the links L.

The store clerk terminal selection unit 67 selects the store clerk S who carries the store clerk terminal 30 and can respond to the support request from the cart terminal 10 based on the length of the path calculated by the path calculation unit 66. More specifically, the store clerk terminal selection unit 67 selects the store clerk terminal 30 that declares to be capable of responding to the support request from the customer C among the store clerk terminals 30 present at a place within a predetermined length of the path from the cart terminal 10 requesting support. The store clerk terminal selection unit 67 is an example of a selection unit.

The support instruction unit 68 instructs the store clerk terminal 30 carried by the store clerk S selected by the store clerk terminal selection unit 67 to support the customer C using the cart terminal 10.

The support acceptance confirmation acquisition unit 69 acquires the information indicating that the instruction is accepted from the store clerk terminal 30 to which the support instruction unit 68 instructs the support for the customer C.

The support acceptance notification unit 70 outputs the information indicating that the store clerk S accepts the support request to the cart terminal 10.

The commodity registration information acquisition unit 71 acquires the commodity registration file 123 and the identification information for uniquely specifying the cart terminal 10 from the cart terminal 10.

The transaction code issuing unit 72 issues the transaction code for uniquely specifying the commodity registration file 123 acquired from the cart terminal 10. Then, the transaction code issuing unit 72 outputs the issued transaction code to the cart terminal 10.

### Flow of Processing Performed by Cart Terminal

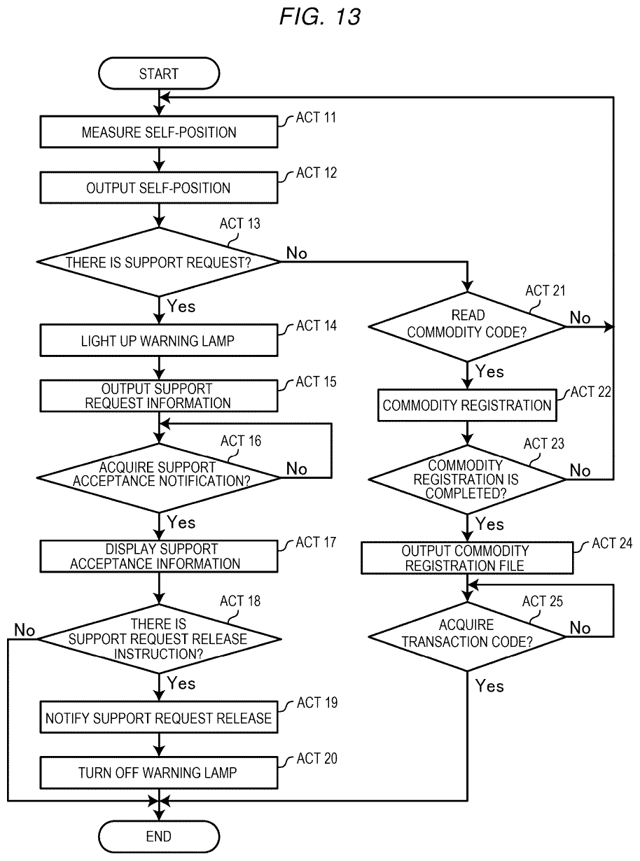

A flow of processing performed by the cart terminal 10 when the customer C issues the support request will be described with reference to FIG. 13. FIG. 13 is a flowchart illustrating an example of the flow of the processing performed by the cart terminal when the customer issues the support request.

The self-position measurement unit 21 measures the current position of the cart terminal 10 (ACT 11).

The self-position measurement unit 21 outputs the current position of the cart terminal 10 to the server device 50 (ACT 12).

The support request unit 22 determines whether there is a support request from the customer C (ACT 13). If it is determined that there is a support request from the customer C (Yes in ACT 13), the processing proceeds to ACT 14. On the other hand, if it is not determined that there is a support request from the customer C (No in ACT 13), the processing proceeds to ACT 21. When detecting that the store clerk call button 162 (see FIG. 10) is pressed, the support request unit 22 determines that there is a support request from the customer C.

In ACT 13, if it is determined that there is a support request from the customer C, the self-position transmission unit 23 lights up the warning lamp 145 in the predetermined light emission color (ACT 14). The self-position transmission unit 23 may blink the warning lamp 145 in the predetermined light emission pattern.

The support request unit 22 requests support from the store clerk S to the server device 50 (ACT 15).

The support acceptance acquisition unit 25 determines whether the information indicating that the store clerk S accepts the support request is acquired from the server device 50 (ACT 16). If it is determined that the information indicating that the store clerk S accepts the support request is acquired (Yes in ACT 16), the processing proceeds to ACT 17. On the other hand, if it is not determined that the information indicating that the store clerk S accepts the support request is acquired (No in ACT 16), the determination in ACT 16 is repeated.

In ACT 16, if it is determined that the information indicating that the store clerk S accepts the support request is acquired, the support acceptance acquisition unit 25 displays the support acceptance information 171 (see FIG. 10) indicating that the store clerk S is going to provide support on the monitor 141 (ACT 17).

The call release unit 24 determines whether there is an instruction to release the support request (ACT 18). If it is determined that there is an instruction to release the support request (Yes in ACT 18), the processing proceeds to ACT 19. On the other hand, if it is not determined that there is an instruction to release the support request for a predetermined time (No in ACT 18), the cart terminal 10 ends the processing.

In ACT 18, if it is determined that there is an instruction to release the support request, the call release unit 24 outputs the information indicating that the support request to the store clerk S is released to the server device 50 (ACT 19).

The call release unit 24 turns off the warning lamp 145 which is lighted up in ACT 14 (ACT 20). Thereafter, the cart terminal 10 ends the processing.

Returning to ACT 13, if it is not determined that there is a support request from the customer C, the commodity code reading unit 26 determines whether the commodity code of the commodity registered in the code symbol held over the scanner 143 is read (ACT 21). If it is determined that the commodity code is read (Yes in ACT 21), the processing proceeds to ACT 22. On the other hand, if it is not determined that the commodity code is read, the processing returns to ACT 11.

In ACT 21, if it is determined that the commodity code is read, the commodity registration unit 27 registers the commodity code read by the commodity code reading unit 26 in the commodity registration file 123 (ACT 22).

The commodity registration unit 27 determines whether the commodity registration is completed (ACT 23). If it is determined that the commodity registration is completed (Yes in ACT 23), the processing proceeds to ACT 24. On the other hand, if it is not determined that the commodity registration is completed (No in ACT 23), the processing returns to ACT 11. When the registration completion button 163 (see FIG. 10) is pressed, the commodity registration unit 27 determines that the commodity registration is completed.

In ACT 23, if it is determined that the commodity registration is completed, the commodity registration information output unit 28 outputs the commodity registration file 123 to the server device 50 in association with the identification information for uniquely specifying the cart terminal 10 (ACT 24).

The transaction code acquisition unit 29 determines whether the transaction code is acquired from the server device 50 (ACT 25). If it is determined that the transaction code is acquired (Yes in ACT 25), the cart terminal 10 ends the processing. On the other hand, if it is not determined that the transaction code is acquired (No in ACT 25), the determination in ACT 25 is repeated.

Although not illustrated in the flowchart in FIG. 13, the customer C who completes the commodity registration moves to a place of the checkout device 80. Then, the customer C causes the monitor 141 of the cart terminal 10 to display the transaction code acquired in ACT 25 described above and causes a scanner (not illustrated) included in the checkout device 80 to read the transaction code. The checkout device 80 acquires the content of the transaction corresponding to the read transaction code, that is, the commodity registration file 123 from the server device 50, and performs checkout of a commodity price based on a method designated by the customer C (for example, cash settlement, credit settlement, electronic money settlement, code settlement, or the like).

### Flow of Processing Performed by Server Device

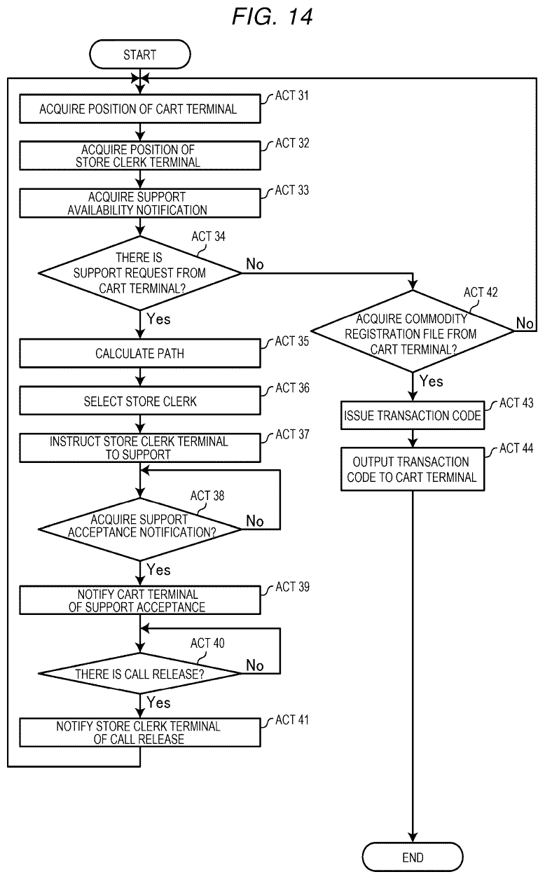

A flow of processing performed by the server device 50 when the customer C issues the support request will be described with reference to FIG. 14. FIG. 14 is a flowchart illustrating an example of the flow of the processing performed by the server device when the customer issues the support request.

The position information acquisition unit 61 acquires the current position of the cart terminal 10 (ACT 31).

The position information acquisition unit 61 acquires the current position of the store clerk terminal 30 (ACT 32).

The response availability acquisition unit 62 acquires, from all the store clerk terminals 30, the information indicating that the support request from the customer C can or cannot be responded to (ACT 33).

The support request acquisition unit 63 determines whether the support request from the cart terminal 10 is acquired (ACT 34). If it is determined that the support request is acquired (Yes in ACT 34), the processing proceeds to ACT 35. On the other hand, if it is not determined that the support request is acquired (No in ACT 34), the processing proceeds to ACT 42.

In ACT 34, if it is determined that the support request is acquired, the path calculation unit 66 calculates the lengths of the paths from the store clerk terminals 30 carried by all the store clerks S who can respond to the support request from the customer C to the customer C (cart terminal 10) who requests support (ACT 35).

The store clerk terminal selection unit 67 selects the store clerk S who carries the store clerk terminal 30 and can respond to the support request from the cart terminal 10 based on the length of the path calculated by the path calculation unit 66 (ACT 36).

The support instruction unit 68 instructs the store clerk terminal 30 carried by the store clerk S selected by the store clerk terminal selection unit 67 to support the customer C using the cart terminal 10 (ACT 37).

The support acceptance confirmation acquisition unit 69 determines whether the information indicating that the instruction of support is accepted is acquired from the store clerk terminal 30 to which the support instruction unit 68 instructs the support for the customer C (ACT 38). If it is determined that the information indicating that the instruction of support is accepted is acquired (Yes in ACT 38), the processing proceeds to ACT 39. On the other hand, if it is not determined that the information indicating that the instruction of support is accepted is acquired (No in ACT 38), the determination in ACT 38 is repeated.

In ACT 38, if it is determined that the information indicating that the instruction of support is accepted is acquired, the support acceptance notification unit 70 outputs information indicating that the store clerk S accepts the support request to the cart terminal 10 that requests support (ACT 39).

The call release acquisition unit 64 determines whether information indicating that the support request is released is acquired from the cart terminal 10 (ACT 40). If it is determined that the information indicating that the support request is released is acquired (Yes in ACT 40), the processing proceeds to ACT 41. On the other hand, if it is not determined that the information indicating that the support request is released is acquired (No in ACT 40), the determination in ACT 40 is repeated.

In ACT 40, if it is determined that the information indicating that the support request is released is acquired, the call release notification unit 65 notifies the store clerk terminal 30 that the support request is released (ACT 41). Thereafter, the processing returns to ACT 31.

Returning to ACT 34, if it is not determined that the support request from the cart terminal 10 is acquired, the commodity registration information acquisition unit 71 determines whether the commodity registration file 123 is acquired from the cart terminal 10 (ACT 42). If it is determined that the commodity registration file 123 is acquired from the cart terminal 10 (Yes in ACT 42), the processing proceeds to ACT 43. On the other hand, if it is not determined that the commodity registration file 123 is acquired from the cart terminal 10 (No in ACT 42), the processing returns to ACT 31.

In ACT 42, if it is determined that the commodity registration file 123 is acquired from the cart terminal 10, the transaction code issuing unit 72 issues the transaction code for uniquely specifying the commodity registration file 123 acquired from the cart terminal 10 (ACT 43).

Subsequently, the transaction code issuing unit 72 outputs the issued transaction code to the cart terminal 10 (ACT 44). Thereafter, the server device 50 ends the processing.

### Flow of Processing Performed by Store Clerk Terminal

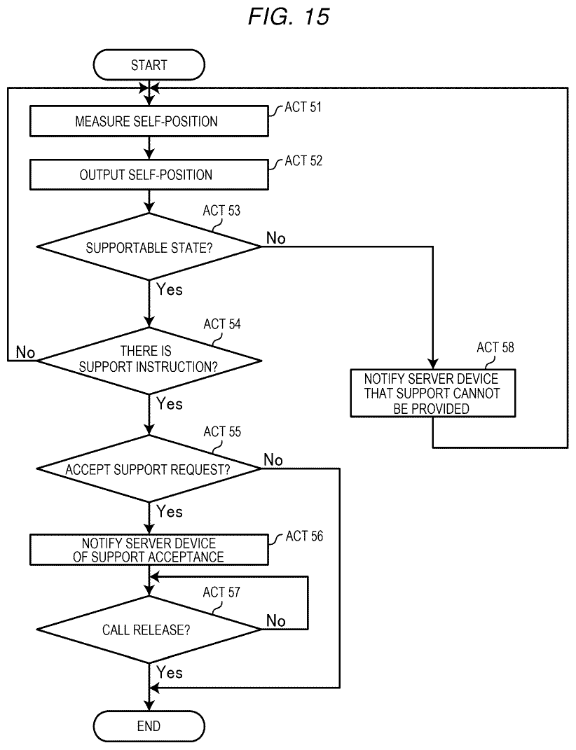

A flow of processing performed by the store clerk terminal 30 when the customer C issues the support request will be described with reference to FIG. 15. FIG. 15 is a flowchart illustrating example of the flow of the processing performed by the store clerk terminal when the customer issues the support request.

The self-position measurement unit 41 measures the current position of the store clerk terminal 30 (ACT 51).

The self-position measurement unit 41 outputs the current position of the store clerk terminal 30 to the server device 50 (ACT 52).

The response availability notification unit 42 determines whether the store clerk is in the state of being capable of responding to the support request from the customer C or in the state of being unable to respond to the support request (ACT 53). If it is determined that the store clerk is in the state of being capable of responding to the support request from the customer C (Yes in ACT 53), the processing proceeds to ACT 54. On the other hand, if it is not determined that the store clerk is in the state of being capable of responding to the support request from the customer C (No in ACT 53), the processing proceeds to ACT 58.

In ACT 53, if it is determined that the store clerk is in the state of being capable of responding to the support request from the customer C, the support instruction acquisition unit 44 determines whether there is a support instruction for the customer C from the server device 50 (ACT 54). If it is determined that there is a support instruction for the customer C (Yes in ACT 54), the processing proceeds to ACT 55. On the other hand, if it is not determined that there is a support instruction for the customer C is made (No in ACT 54), the processing returns to ACT 51.

In ACT 54, if it is determined that there is a support instruction for the customer C, the support acceptance notification unit 45 determines whether the support request is accepted (ACT 55). If it is determined that the support request is accepted (Yes in ACT 55), the processing proceeds to ACT 56. On the other hand, if it is not determined that the support request is accepted (No in ACT 55), the store clerk terminal 30 ends the processing. When the support response acceptance button 382 (see FIG. 11) displayed on the monitor 341 of the store clerk terminal 30 is pressed, the support acceptance notification unit 45 determines that the store clerk S carrying the store clerk terminal 30 accepts the support request. In contrast, when the support response unavailable button 383 (see FIG. 11) displayed on the monitor 341 of the store clerk terminal 30 is pressed, it is not determined that the store clerk S carrying the store clerk terminal 30 accepts the support request.

In ACT 55, if it is determined that the store clerk S carrying the store clerk terminal 30 accepts the support request, the support acceptance notification unit 45 notifies the server device 50 of information indicating that the store clerk S carrying the store clerk terminal 30 accepts the support request (ACT 56). Thereafter, the store clerk S moves to the customer C along the movement route 392 displayed on the monitor 341 of the store clerk terminal 30 to support the customer C.

The call release acquisition unit 43 determines whether the information indicating that the support request from the customer C is released is acquired from the server device 50 (ACT 57). If it is determined that the information indicating that the support request from the customer C is released is acquired (Yes in ACT 57), the call release acquisition unit 43 deletes the support request received in ACT 55, and the store clerk terminal 30 ends the processing. On the other hand, if it is not determined that the information indicating that the support request from the customer C is released is acquired, the determination in ACT 57 is repeated.

Returning to ACT 53, if it is not determined that the store clerk is in the state of being capable of responding to the support request from the customer C, the response availability notification unit 42 notifies the server device 50 of the information indicating that the support request from the customer C cannot be responded to (ACT 58). Thereafter, the processing returns to ACT 51.

### Effects of Embodiments

As described above, the shopping support system 1 according to the present embodiment includes the cart terminal 10 (first terminal device) that is carried by the customer C in the store during shopping, the store clerk terminal 30 (second terminal device) carried by the store clerk S, and the server device 50 communicably connected to the cart terminal 10 and the store clerk terminal 30. The cart terminal 10 includes the self-position measurement unit 21 (first position specifying unit) that specifies a position of the cart terminal 10 in the store and outputs the specified position to the server device 50, the support request unit 22 that receives an instruction from the customer C and requests support from the store clerk S, and the self-position transmission unit 23 that transmits presence of the cart terminal 10 to the surroundings when the support request unit 22 requests support. The server device 50 includes the position information acquisition unit 61 that acquires current positions of the cart terminal 10 and the store clerk terminal 30, the support request acquisition unit 63 that acquires a support request from the cart terminal 10, the path calculation unit 66 that calculates a length of a path along a passage in the store between the cart terminal 10 and the store clerk terminal 30 based on the position of the cart terminal 10, the position of the store clerk terminal 30, and the store map data 522 (map information) in which a structure of the passage and information about a length of the passage are stored, the store clerk terminal selection unit 67 (selection unit) that selects the store clerk S who carries the store clerk terminal 30 and can respond to the support request from the cart terminal 10 based on the length of the path calculated by the path calculation unit 66, and the support instruction unit 68 that instructs the store clerk terminal 30 carried by the store clerk S selected by the store clerk terminal selection unit 67 to support the customer C using the cart terminal 10. The store clerk terminal 30 includes the self-position measurement unit 41 (second position specifying unit) that specifies a position of the store clerk terminal 30 in the store and outputs the specified position to the server device 50, and the support instruction acquisition unit 44 that acquires a support instruction for the customer C using the cart terminal 10 that requests support from the server device 50. Therefore, the store clerk S who can respond to the support request from the customer C can be dispatched to support the customer C.

In the shopping support system 1 according to the present embodiment, the store map data 522 (map information) represents the structure of the passage in the store by the nodes N indicating coordinate positions and the link L connecting the nodes. The link L stores the link length P which is the length of the link L and the weight w which is a coefficient to be multiplied by the link length P when calculating the path. The path calculation unit 66 calculates the path based on a sum of multiplied values of the link lengths P and the weights w of the links. Therefore, since the weight w can be given to the link, whether preparation on how quickly the support for the customer can be responded to is performed can be set.

In the shopping support system 1 according to the present embodiment, the weight w larger than 1 is given to the link L from the sales floor of the store to the back office. Therefore, the store clerk S taking a break in the back office is less likely to respond to the support request from the customer C with respect to the store clerk S in the store.

In addition, in the shopping support system 1 according to the present embodiment, the store clerk terminal 30 further includes a response availability notification unit 42 that outputs information indicating that the support request from the customer C can be responded to the server device 50 and that the support request from the customer C cannot be handled, and the support instruction unit 68 of the server device 50 does not instruct the store clerk terminal 30 that outputs information indicating that the support request from the customer C cannot be handled, to support the customer C. In response to the store clerk S that cannot respond to the support request, even when the store clerk S is in the vicinity of the customer C who has requested the support, it is possible not to instruct the customer C to support the support.

In addition, in the shopping support system 1 of the present embodiment, the support instruction unit 68 instructs, to support the customer C, the store clerk terminal 30 that declares that the support request from the customer C can be responded to among the store clerk terminals 30 present in a place within the predetermined path length from the cart terminal 10. In a case where there are a plurality of store clerks S capable of responding to the support request from the customer C, the support of the customer C can be instructed to the plurality of store clerks S serving as candidates. Accordingly, the number of branches to be selected of the store clerks S toward the support can be increased.

While embodiments have been described, the embodiments have been presented by way of example and are not intended to limit the scope of the exemplary embodiments. The novel embodiments can be implemented in various other forms, and various omissions, substitutions, and modifications can be made without departing from the gist of the exemplary embodiments. The embodiments and the modifications thereof are included in the scope and the gist of the exemplary embodiments and are included in the scope of the exemplary embodiments disclosed in the claims and equivalents thereof.

What is claimed is:

1. A shopping support system, comprising:
a first terminal device configured to be carried by a customer in a store during shopping;
a second terminal device configured to be carried by a store clerk; and
a server device configured to be communicably connected to the first terminal device and the second terminal device, wherein
the first terminal device includes:
a first position specifying component configured to specify a position of the first terminal device in the store and output the specified position to the server device;
a support request component configured to receive an instruction from the customer and request support from the store clerk; and
a self-position transmission component configured to transmit presence of the first terminal device to surroundings when the support request component requests support,
the server device includes:
a position n information acquisition component configured to acquire current positions of the first terminal device and the second terminal device;
a support request acquisition component configured to acquire a support request from the first terminal device;
a path calculation component configured to calculate a length of a path along a passage in the store between the first terminal device and the second terminal device based on the position of the first terminal device, the position of the second terminal device, and map information storing a structure of the passage and information about a length of the passage;
a selection component configured to select a store clerk who carries the second terminal device and is capable of responding to the support request from the first terminal device based on the length of the path calculated by the path calculation component; and
a support instruction component configured to instruct the second terminal device carried by the store clerk selected by the selection component of support for the customer using the first terminal device, and
the second terminal device includes:
a second position specifying component configured to specify the position of the second terminal device in the store and output the specified position to the server device; and
a support instruction acquisition component configured to acquire, from the server device, a support instruction for the customer who uses the first terminal device and requests support.

2. The shopping support system according to claim 1, wherein
the map information represents the structure of the passage in the store by nodes indicating coordinate positions and links connecting the nodes,
each link stores a link length that is a length of the link and a link weight that is a coefficient to be multiplied to the link length when the path is calculated, and
the path calculation component calculates the path based on a sum of multiplied values of the link length and the link weight.

3. The shopping support system according to claim 2, wherein
a link weight larger than 1 is given to a link from a sales floor of the store to a back office.

4. The shopping support system according to claim 1, wherein
the second terminal device further includes
a response availability notification component configured to output, to the server device, information indicating that the support request from the customer can or cannot be responded to, and
the support instruction component of the server device does not instruct, to support the customer, a second terminal device that outputs the information indicating that the support request from the customer cannot be responded to.

5. The shopping support system according to claim 4, wherein
the support instruction component instructs, to support the customer, the second terminal device that declares that the support request from the customer is respondable to among second terminal devices present t in a place within a predetermined path length from the first terminal device.

6. The shopping support system according to claim 1, wherein
the first terminal device is affixed to a wheeled shopping cart.

7. The shopping support system according to claim 1, wherein
the first terminal device is affixed to a hand-held shopping cart.

8. A shopping support method, comprising:
specifying a position in a store of a first terminal device carried by a customer in the store during shopping and outputting the specified position to a server device;
receiving an instruction from the customer and requesting support from a store clerk;
transmitting presence of the first terminal device to surroundings when support is requested;
specifying a position in the store of a second terminal device carried by the store clerk and outputting the specified position to the server device;
acquiring a support instruction for the customer using the first terminal device that requests support from the server device;
acquiring current positions of the first terminal device and the second terminal device;
acquiring a support request from the first terminal device;
calculating a length of a path along a passage in the store between the first terminal device and the second terminal device based on the position of the first terminal device, the position of the second terminal device, and map information storing of a structure the passage and information about a length of the passage;
selecting a store clerk who carries the second terminal device and is capable of responding to the support request from the first terminal device based on the calculated length of the path; and
instructing the second terminal device carried by the selected store clerk of the support for the customer using the first terminal device.

9. The shopping support method according to claim 8, wherein
the map information represents the structure of the passage in the store by nodes indicating coordinate positions and links connecting the nodes,
each link stores a link length that is a length of the link and a link weight that is a coefficient to be multiplied to the link length when the path is calculated, and further comprising:
calculating the path based on a sum of multiplied values of the link length and the link weight.

10. The shopping support method according to claim 9, wherein
a link weight larger than 1 is given to a link from a sales floor of the store to a back office.

11. The shopping support method according to claim 8, further comprising:
outputting, by a response availability notification component to the server device, information indicating that the support request from the customer can or cannot be responded to, and
not instructing, to support the customer, a second terminal device that outputs the information indicating that the support request from the customer cannot be responded to.

12. The shopping support method according to claim 11, further comprising:
instructing, to support the customer, the second terminal device that declares that the support request from the customer is respondable to among second terminal devices present in a place within a predetermined path length from the first terminal device.

13. The shopping support system according to claim 8, wherein
the first terminal device is affixed to a wheeled shopping cart.

14. A shopping support device configured to be carried by a customer in a store during shopping, comprising:
a first position specifying component configured to specify a position of the shopping support device in the store and output the specified position to a server device;
a support request component configured to receive an instruction from the customer and request support from a store clerk carrying a terminal device; and
a self-position transmission component configured to transmit presence of the shopping support device to surroundings when the support request component requests support,
wherein the server device includes:
a position information acquisition component configured to acquire current positions of the shopping support device and the terminal device;
a support request acquisition component configured to acquire a support request from the shopping support device;
a path calculation component configured to calculate a length of a path along a passage in the store between the shopping support device and the terminal device based on the position of the shopping support device, the position of the terminal device, and map information storing a structure of the passage and information about a length of the passage;
a selection component configured to select a store clerk who carries the terminal device and is capable of responding to the support request from the shopping support device based on the length of the path calculated by the path calculation component; and
a support instruction component configured to instruct the terminal device carried by the store clerk selected by the selection component of support for the customer using the shopping support device.

15. The shopping support device according to claim 14, wherein
the map information represents the structure of the passage in the store by nodes indicating coordinate positions and links connecting the nodes,
each link stores a link length that is a length of the link and a link weight that is a coefficient to be multiplied to the link length when the path is calculated, and
the path calculation component calculates the path based on a sum of multiplied values of the link length and the link weight.

16. The shopping support device according to claim 15, wherein
a link weight larger than 1 is given to a link from a sales floor of the store to a back office.

17. The shopping support device according to claim 14, wherein
the support instruction component instructs, to support the customer, the terminal device that declares that the support request from the customer is respondable to among terminal devices present in a place within a predetermined path length from the shopping support device.

18. The shopping support device according to claim 14, wherein
the shopping support device is affixed to a wheeled shopping cart.

19. The shopping support device according to claim 14, wherein
the shopping support device is affixed to a hand-held shopping cart.
